(19) United States
(12) Patent Application Publication
(10) Pub. No.: US 2026/0031871 A1
(43) Pub. Date: Jan. 29, 2026

(54) LOW POWER WIDEBAND CHANNEL STATE INFORMATION REPORTING

(71) Applicant: QUALCOMM Incorporated, San Diego, CA (US)

(72) Inventors: Diana MAAMARI, San Diego, CA (US); Gabi SARKIS, San Diego, CA (US); Jing JIANG, San Diego, CA (US)

(21) Appl. No.: 18/786,177

(22) Filed: Jul. 26, 2024

(51) Int. Cl. H04B 7/06; H04W 72/21

(52) U.S. Cl. CPC H04B 7/0626; H04W 72/21

(57) ABSTRACT

Methods, systems, and devices for wireless communications are described. In some examples, a network entity may trigger a user equipment (UE) to report wideband (WB) channel state information (CSI). The UE may perform WB CSI reporting in a low-power state in accordance with a relaxed processing timeline configured by the network entity. In some examples, the UE may refrain from monitoring WB for a duration of time after a WB CSI trigger in accordance with a timer or in accordance with a reporting cycle. The UE may compute the WB CSI during the duration in accordance with the relaxed processing timeline. The UE may refrain from transitioning to a high-power state to perform WB CSI reporting for the duration, which may reduce overall power consumption at the UE.

### FIELD OF TECHNOLOGY

The present disclosure relates to wireless communications, including low-power wideband channel state information reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first configuration information for downlink scheduling in accordance with a first threshold throughput and second configuration information for downlink scheduling in accordance with a second threshold throughput, where the second threshold throughput is less than the first threshold throughput, receiving one or more channel state information (CSI) triggers that is associated with the second configuration information, where a quantity of the one or more CSI triggers is less than a threshold quantity of CSI triggers supported by the UE for the second configuration information, and transmitting a report indicating CSI for one or more reference signals in accordance with a second processing timeline associated with the second configuration information, where the second processing timeline is longer than a first processing timeline associated with the first configuration information.

A UE for wireless communications is described. The UE may include one or more memories storing processor executable code, and one or more processors coupled with the one or more memories. The one or more processors may individually or collectively be operable to execute the code to cause the UE to receive first configuration information for downlink scheduling in accordance with a first threshold throughput and second configuration information for downlink scheduling in accordance with a second threshold throughput, where the second threshold throughput is less than the first threshold throughput, receive one or more CSI triggers that is associated with the second configuration information, where a quantity of the one or more CSI triggers is less than a threshold quantity of CSI triggers supported by the UE for the second configuration information, and transmit a report indicating CSI for one or more reference signals in accordance with a second processing timeline associated with the second configuration information, where the second processing timeline is longer than a first processing timeline associated with the first configuration information.

Another UE for wireless communications is described. The UE may include means for receiving first configuration information for downlink scheduling in accordance with a first threshold throughput and second configuration information for downlink scheduling in accordance with a second threshold throughput, where the second threshold throughput is less than the first threshold throughput, means for receiving one or more CSI triggers that is associated with the second configuration information, where a quantity of the one or more CSI triggers is less than a threshold quantity of CSI triggers supported by the UE for the second configuration information, and means for transmitting a report indicating CSI for one or more reference signals in accordance with a second processing timeline associated with the second configuration information, where the second processing timeline is longer than a first processing timeline associated with the first configuration information.

A non-transitory computer-readable medium storing code for wireless communications is described. The code may include instructions executable by one or more processors to receive first configuration information for downlink scheduling in accordance with a first threshold throughput and second configuration information for downlink scheduling in accordance with a second threshold throughput, where the second threshold throughput is less than the first threshold throughput, receive one or more CSI triggers that is associated with the second configuration information, where a quantity of the one or more CSI triggers is less than a threshold quantity of CSI triggers supported by the UE for the second configuration information, and transmit a report indicating CSI for one or more reference signals in accordance with a second processing timeline associated with the second configuration information, where the second processing timeline is longer than a first processing timeline associated with the first configuration information.

In some examples of the method, UEs, and non-transitory computer-readable medium described herein, receiving the one or more CSI triggers may include operations, features, means, or instructions for receiving control information including the one or more CSI triggers and scheduling a physical uplink shared channel (PUSCH) for transmitting the report indicating the CSI, where the first processing timeline may be scaled by a scaling factor to obtain the second processing timeline based on the control information including the one or more CSI triggers and scheduling the PUSCH for transmitting the report indicating the CSI.

Some examples of the method, UEs, and non-transitory computer-readable medium described herein may further include operations, features, means, or instructions for receiving control information scheduling an PUSCH, where the PUSCH may be scheduled in accordance with the second processing timeline and in accordance with a timeline threshold.

Some examples of the method, UEs, and non-transitory computer-readable medium described herein may further include operations, features, means, or instructions for receiving control information indicating to initiate a timer, where monitoring of a control channel may be skipped prior to expiration of the timer.

In some examples of the method, UEs, and non-transitory computer-readable medium described herein, the timer may be restarted upon reception of each of the one or more CSI triggers.

Some examples of the method, UEs, and non-transitory computer-readable medium described herein may further include operations, features, means, or instructions for receiving a control message indicating a reporting cycle configuration for transmitting the report indicating the CSI and transmitting one or more CSI reports in accordance with the reporting cycle configuration.

In some examples of the method, UEs, and non-transitory computer-readable medium described herein, the reporting cycle configuration indicates a duration, a slot offset, a periodicity, an active time, an inactive time, or any combination thereof.

Some examples of the method, UEs, and non-transitory computer-readable medium described herein may further include operations, features, means, or instructions for receiving a control message indicating a reporting cycle configuration that identifies a reporting cycle, the reporting cycle including an active time duration and an inactive time duration, where the one or more CSI triggers may be received and the report may be transmitted within a same active time duration of the reporting cycle.

Some examples of the method, UEs, and non-transitory computer-readable medium described herein may further include operations, features, means, or instructions for receiving a control message indicating a reporting cycle configuration that identifies a reporting cycle, the reporting cycle including an active time duration and an inactive time duration, where the one or more CSI triggers may be received during a first active time duration of the reporting cycle and the report may be transmitted during a second active time duration of the reporting cycle, and where the first active time duration differs from the second active time duration.

Some examples of the method, UEs, and non-transitory computer-readable medium described herein may further include operations, features, means, or instructions for transmitting assistance information, the assistance information indicating the threshold quantity of CSI triggers supported by the UE for the second configuration information, a second quantity of CSI triggers supported by the UE for the first configuration information, a threshold time duration between the one or more CSI triggers, or any combination thereof.

Some examples of the method, UEs, and non-transitory computer-readable medium described herein may further include operations, features, means, or instructions for monitoring a first bandwidth for the one or more reference signals in accordance with the second configuration information and the one or more CSI triggers, where the one or more CSI triggers indicate to monitor for the one or more reference signals, and where the first bandwidth exceeds a second bandwidth.

In some examples of the method, UEs, and non-transitory computer-readable medium described herein, the second configuration information may be associated with a lower power consumption than the first configuration information.

In some examples of the method, UEs, and non-transitory computer-readable medium described herein, the report indicating the CSI may be a periodic CSI report, a semi-persistent CSI report, or an aperiodic CSI report.

A method for wireless communications by a network entity is described. The method may include outputting first configuration information for downlink scheduling in accordance with a first threshold throughput and second configuration information for downlink scheduling in accordance with a second threshold throughput, where the second threshold throughput is less than the first threshold throughput, outputting one or more CSI triggers that is associated with the second configuration information, where a quantity of the one or more CSI triggers is less than a threshold quantity of CSI triggers supported by a UE for the second configuration information, and obtaining a report indicating CSI for one or more reference signals in accordance with a second processing timeline associated with the second configuration information, where the second processing timeline is longer than a first processing timeline associated with the first configuration information.

A network entity for wireless communications is described. The network entity may include one or more memories storing processor executable code, and one or more processors coupled with the one or more memories. The one or more processors may individually or collectively be operable to execute the code to cause the network entity to output first configuration information for downlink scheduling in accordance with a first threshold throughput and second configuration information for downlink scheduling in accordance with a second threshold throughput, where the second threshold throughput is less than the first threshold throughput, output one or more CSI triggers that is associated with the second configuration information, where a quantity of the one or more CSI triggers is less than a threshold quantity of CSI triggers supported by a UE for the second configuration information, and obtain a report indicating CSI for one or more reference signals in accordance with a second processing timeline associated with the second configuration information, where the second processing timeline is longer than a first processing timeline associated with the first configuration information.

Another network entity for wireless communications is described. The network entity may include means for outputting first configuration information for downlink scheduling in accordance with a first threshold throughput and second configuration information for downlink scheduling in accordance with a second threshold throughput, where the second threshold throughput is less than the first threshold throughput, means for outputting one or more CSI triggers that is associated with the second configuration information, where a quantity of the one or more CSI triggers is less than a threshold quantity of CSI triggers supported by a UE for the second configuration information, and means for obtaining a report indicating CSI for one or more reference signals in accordance with a second processing timeline associated with the second configuration information, where the second processing timeline is longer than a first processing timeline associated with the first configuration information.

A non-transitory computer-readable medium storing code for wireless communications is described. The code may include instructions executable by one or more processors to output first configuration information for downlink scheduling in accordance with a first threshold throughput and second configuration information for downlink scheduling in accordance with a second threshold throughput, where the second threshold throughput is less than the first threshold throughput, output one or more CSI triggers that is associated with the second configuration information, where a quantity of the one or more CSI triggers is less than a threshold quantity of CSI triggers supported by a UE for the second configuration information, and obtain a report indicating CSI for one or more reference signals in accordance with a second processing timeline associated with the second configuration information, where the second processing timeline is longer than a first processing timeline associated with the first configuration information.

In some examples of the method, network entities, and non-transitory computer-readable medium described herein, outputting the one or more CSI triggers may include operations, features, means, or instructions for outputting control information including the one or more CSI triggers and scheduling an PUSCH for the report indicating the CSI, where the first processing timeline may be scaled by a scaling factor to obtain the second processing timeline based on the control information including the one or more CSI triggers and scheduling the PUSCH for the report indicating the CSI.

Some examples of the method, network entities, and non-transitory computer-readable medium described herein may further include operations, features, means, or instructions for outputting control information scheduling an PUSCH, where the PUSCH may be scheduled in accordance with the second processing timeline and in accordance with a timeline threshold.

Some examples of the method, network entities, and non-transitory computer-readable medium described herein may further include operations, features, means, or instructions for outputting control information indicating to initiate a timer, where monitoring of a control channel may be skipped prior to expiration of the timer.

In some examples of the method, network entities, and non-transitory computer-readable medium described herein, the timer may be restarted upon output of each of the one or more CSI triggers.

Some examples of the method, network entities, and non-transitory computer-readable medium described herein may further include operations, features, means, or instructions for outputting a control message indicating a reporting cycle configuration for the report indicating the CSI and obtaining one or more CSI reports in accordance with the reporting cycle configuration.

In some examples of the method, network entities, and non-transitory computer-readable medium described herein, the reporting cycle configuration indicates a duration, a slot offset, a periodicity, an active time, an inactive time, or any combination thereof.

Some examples of the method, network entities, and non-transitory computer-readable medium described herein may further include operations, features, means, or instructions for outputting a control message indicating a reporting cycle configuration that identifies a reporting cycle, the reporting cycle including an active time duration and an inactive time duration, where the one or more CSI triggers may be output and the report may be obtained within a same active time duration of the reporting cycle.

Some examples of the method, network entities, and non-transitory computer-readable medium described herein may further include operations, features, means, or instructions for outputting a control message indicating a reporting cycle configuration that identifies a reporting cycle, the reporting cycle including an active time duration and an inactive time duration, where the one or more CSI triggers may be output during a first active time duration of the reporting cycle and the report may be obtained during a second active time duration of the reporting cycle, and where the first active time duration differs from the second active time duration.

Some examples of the method, network entities, and non-transitory computer-readable medium described herein may further include operations, features, means, or instructions for obtaining assistance information, the assistance information indicating the threshold quantity of CSI triggers supported by the UE for the second configuration information, a second quantity of CSI triggers supported by the UE for the first configuration information, a threshold time duration between the one or more CSI triggers, or any combination thereof, where the one or more CSI triggers may be output in accordance with the assistance information.

In some examples of the method, network entities, and non-transitory computer-readable medium described herein, the second configuration information may be associated with a lower power consumption than the first configuration information.

In some examples of the method, network entities, and non-transitory computer-readable medium described herein, the report indicating the CSI may be a periodic CSI report, a semi-persistent CSI report, or an aperiodic CSI report.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports low-power wideband (WB) channel state information (CSI) reporting in accordance with one or more aspects of the present disclosure.

FIG. 2 shows an example of a wireless communications system that supports low-power WB CSI reporting in accordance with one or more aspects of the present disclosure.

FIG. 3 shows an example of a process flow that supports low-power WB CSI reporting in accordance with one or more aspects of the present disclosure.

FIGS. 4 and 5 show block diagrams of devices that support low-power WB CSI reporting in accordance with one or more aspects of the present disclosure.

FIG. 6 shows a block diagram of a communications manager that supports low-power WB CSI reporting in accordance with one or more aspects of the present disclosure.

FIG. 7 shows a diagram of a system including a device that supports low-power WB CSI reporting in accordance with one or more aspects of the present disclosure.

FIGS. 8 and 9 show block diagrams of devices that support low-power WB CSI reporting in accordance with one or more aspects of the present disclosure.

FIG. 10 shows a block diagram of a communications manager that supports low-power WB CSI reporting in accordance with one or more aspects of the present disclosure.

FIG. 11 shows a diagram of a system including a device that supports low-power WB CSI reporting in accordance with one or more aspects of the present disclosure.

FIGS. 12 and 13 show flowcharts illustrating methods that support low-power WB CSI reporting in accordance with one or more aspects of the present disclosure.

### DETAILED DESCRIPTION

In some wireless communications systems, wireless devices may communicate via frequency bands. For example, a user equipment (UE) may communicate with a network entity via a narrowband (NB). In some examples, the UE and the network entity may support wideband (WB) communications, which may improve data throughput. However, the UE may transition into a high-power state for WB communications, which may increase power consumption at the UE relative to NB communication. For example, the UE may increase a frequency and a supply voltage of a baseband clock of the UE for WB communications. Additionally, the UE may be configured to perform channel state information (CSI) reporting. For example, the UE may receive signaling from the network entity triggering the UE to perform CSI reporting. Accordingly, the UE may monitor for and measure reference signaling (e.g., CSI reference signals (CSI-RS) from the network entity to compute CSI. In some examples, the UE may be configured to perform CSI reporting for WB.

Various aspects of the present disclosure are related to low-power WB CSI reporting. In some examples, a UE may be configured to perform WB CSI reporting. A network entity may trigger the UE to perform the WB CSI reporting by transmitting one or more CSI triggers to the UE via WB. The UE may receive the WB CSI triggers and corresponding WB CSI-RS, perform channel measurements, compute the WB CSI, and transmit a WB CSI report without transitioning to the high-power state in accordance with a relaxed processing timeline. In some examples, the network entity may limit a quantity of back-to-back WB CSI triggers such that there are no scheduled transmissions to the UE for a duration after a final WB CSI trigger. In some other examples, the UE may refrain from monitoring for WB signaling accordance with a timer or in accordance with a reporting cycle configured by the network entity. The network entity may configure the UE for WB CSI reporting in accordance with the relaxed processing timeline based on assistance information received from the UE. The relaxed processing timeline may provide the UE with additional time to calculate WB CSI such that the UE may remain in a low-power state when performing WB CSI reporting, which may reduce overall power consumption at the UE. In some examples, the UE may be configured to receive additional control signaling from the network entity via WB, including synchronization signal blocks (SSBs) or tracking reference signals (TRSs). In such cases, the UE may receive the SSBs, the TRSs, or both, via WB while in the low-power state.

Aspects of the disclosure are initially described in the context of wireless communications systems. Aspects of the disclosure are additionally illustrated with reference to process flows. Aspects of the disclosure are further illustrated by and described with reference to apparatus diagrams, system diagrams, and flowcharts that relate to low-power WB CSI reporting.

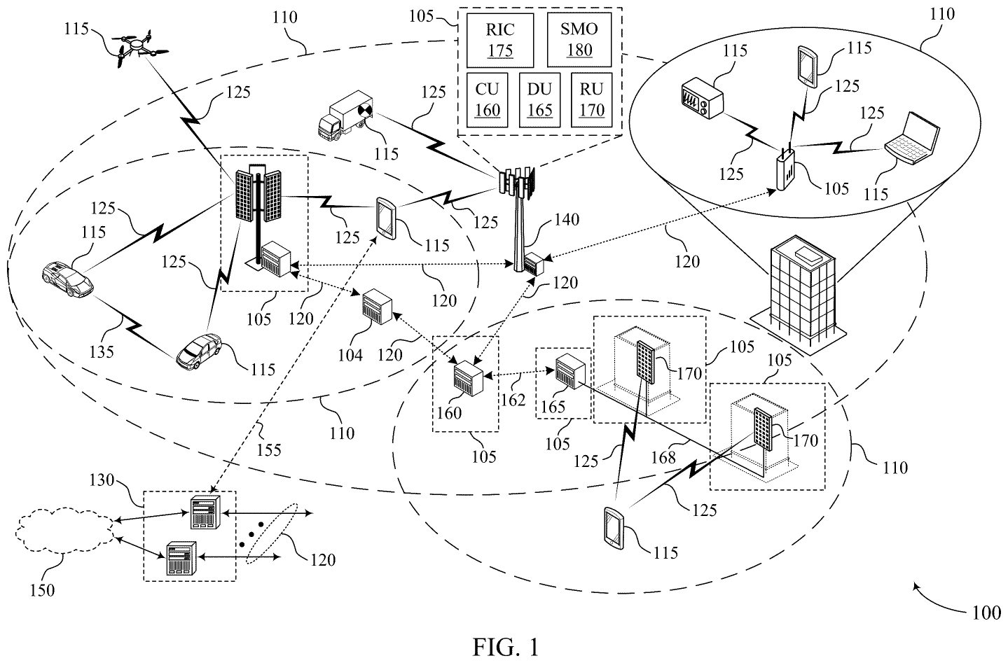

FIG. 1 shows an example of a wireless communications system 100 that supports low-power WB CSI reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Afₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband (NB) communications), or a combination of these techniques. For example, some UEs 115 may be configured for operation using a NB protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may be configured to perform CSI reporting over WB. For example, a network entity 105 may trigger the UE 115 to perform WB CSI reporting by transmitting one or more CSI triggers to the UE 115 via WB. The UE 115 may receive the WB CSI triggers and corresponding WB CSI-RS, perform channel measurements with the WB CSI-RS, compute the WB CSI, and transmit a WB CSI report via PUSCH without transitioning to a high-power state associated with WB communications. The UE 115-a may remain in a low-power state while performing WB CSI reporting in accordance with a relaxed processing timeline. In some examples, the network entity 105 may limit a quantity of back-to-back WB CSI triggers transmitted to the UE 115 such the UE 115 is not scheduled for a duration after a final WB CSI trigger. In some other examples, the UE 115 may refrain from monitoring for WB signaling that would schedule a WB PUSCH for transmitting the WB CSI report in accordance with a timer. In some other examples, the UE 115 may perform WB CSI reporting in accordance with a reporting cycle configured by the network entity 105. The network entity 105 may configure the UE 115 for WB CSI reporting in accordance with the relaxed processing timeline based on assistance information received from the UE 115. The relaxed processing timeline may provide the UE 115 with additional time to calculate WB CSI such that the UE 115 may remain in a low-power state when performing WB CSI reporting, which may reduce overall power consumption at the UE 115. In some examples, the UE 115 may be configured to receive additional control signaling from the network entity 105 via WB, including SSBs, TRSs, or both. In such cases, the UE 115 may be configured to receive the SSBs, the TRSs, or both, via WB in accordance with the relaxed processing timeline. The UE 115 may perform cell acquisition and tracking via WB while in the low-power state.

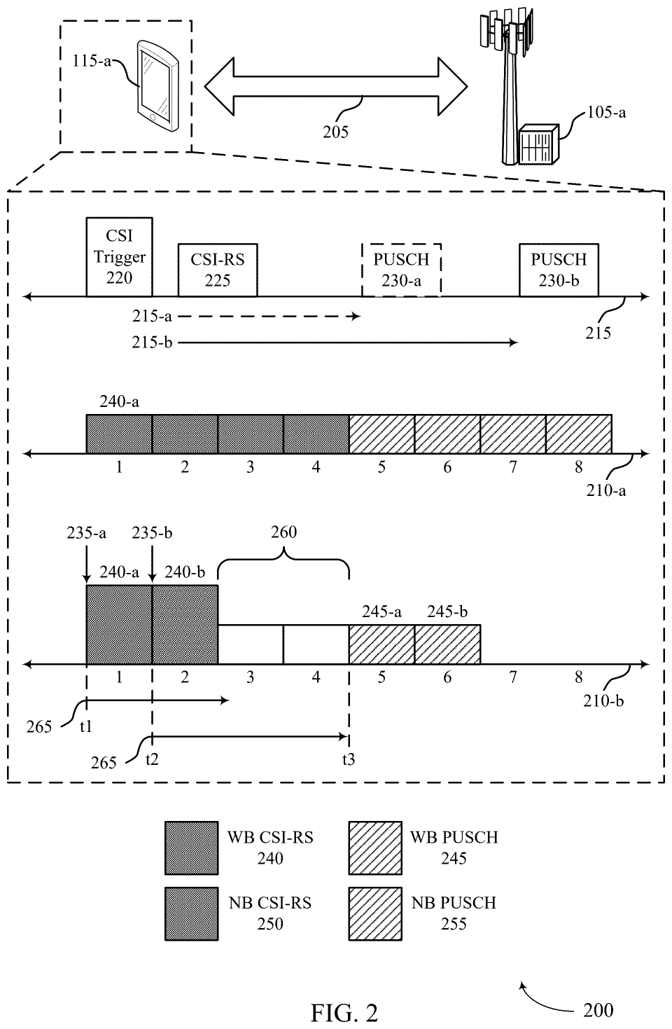

FIG. 2 shows an example of a wireless communications system 200 that supports low-power WB CSI reporting in accordance with one or more aspects of the present disclosure. The wireless communications system 200 may include a UE 115-a in communications with a network entity 105-a, which may be examples of corresponding devices as described herein, including with reference to FIG. 1. The UE 115-a may communicate with the network entity 105-a via a communication link 205 (e.g., via uplink, downlink, or both). In some examples, the UE 115-a may support both NB communications and WB communications. For example, the UE 115-a may be scheduled to communicate signaling via NB for a first quantity of slots and may be scheduled to communicate signaling via WB (e.g., broadband) for a second quantity of slots, which may be the same as, or different from, the first quantity of slots. In the example of FIG. 2, the UE 115-a may operate in accordance with a NB timeline 210-a and a WB timeline 210-b.

WB communications may support increased throughput relative to NB communications, and the UE 115-a may enter a high-power state to communicate via WB. To support the high-power state, the UE 115-a may increase a clock frequency of the UE 115-a. The UE 115-a may also increase a supply voltage of the UE 115-a to support the increased clock frequency, which may significantly increase power consumption and charge leakage when operating in WB. For example, the UE 115-a may adjust an internal baseband clock of the UE 115-a, may adjust an internal baseband voltage of the UE 115-a, or both, to support the high-power state for WB. To mitigate the effects of operating the UE 115-a in the high-power state, the network entity 105-a may indicate WB scheduling information to the UE 115-a such that the UE 115-a may adjust a clock frequency of the UE 115-a, a clock voltage of the UE 115-a, or both, based on whether the UE 115-a is scheduled for WB communications.

The UE 115-a may receive first configuration information for downlink scheduling from the network entity 105-a for the high-power state. The first configuration information may be associated with baseline CSI reporting (e.g., NB CSI reporting, WB CSI reporting). The baseline CSI reporting may have a first processing timeline that is shorter than the relaxed processing timeline, and the UE 115-a may operate in a high power state to comply with the shorter processing timeline. The UE 115-a may also receive second configuration information for downlink scheduling from the network entity 105-a for a lower-power state. The second configuration information may be associated with low-power CSI reporting (e.g., low-power WB CSI reporting). In some examples, the first configuration information may be associated with a first threshold throughput for the downlink scheduling (e.g., a high data threshold throughput), and the second configuration information may be associated with a second threshold throughput for the downlink scheduling, which may be a lower data throughput relative to the first threshold throughput. A threshold throughput may correspond to how many computations a UE performs within a time duration, and corresponds to which power state the UE operates to meet a certain processing deadline (e.g., according to a processing timeline as discussed herein). A lower threshold throughput may permit a permit a UE to operate in a lower power state. Additionally, or alternatively, the first configuration information may be associated with a first processing timeline (e.g., a baseline timeline), and the second configuration information may be associated with a second processing timeline (e.g., an energy efficient scheduling timeline, a low-power timeline) that is longer in time than the first processing timeline. The second processing timeline may permit the UE 115-a to perform CSI-RS measurement, CSI calculation, and CSI reporting, while operating in the lower power state.

In some examples, the UE 115-a may be configured to perform CSI reporting in accordance with a processing timeline 215 (e.g., a first processing timeline 215-a, a second processing timeline 215-b) The processing timeline may indicate a duration over which the UE 115-a may perform channel measurements and calculate the CSI. For example, the UE 115-a may receive downlink control information (DCI) from the network entity 105-a including a CSI trigger 220 (e.g., a CSI request). The network entity 105-a may transmit the DCI via a physical downlink control channel (PDCCH). The UE 115-a may receive the DCI including the CSI trigger 220 and may monitor for CSI-RS 225 from the network entity 105-a. If the UE 115-a detects CSI-RS 225, the UE 115-a may perform measurements with the CSI-RS 225 to calculate CSI. The UE 115-a may transmit a CSI report via a physical uplink shared channel (PUSCH) 230 to the network entity 105-a after measuring the CSI-RS 225. In some cases, the network entity 105-a may transmit the CSI trigger 220 and may schedule the PUSCH 230 for transmitting the CSI report corresponding to the CSI trigger 220 using the same DCI. In some other cases, the network entity 105-a may schedule the PUSCH 230 separately from the DCI that includes the CSI trigger 220.

In some examples, the UE 115-a may be scheduled to transmit the CSI report via a first PUSCH 230-a in accordance with the first processing timeline 215-a. In such examples, the UE 115-a may measure the CSI-RS 225 and calculate the CSI within the first processing timeline 215-a to transmit the CSI report via the first PUSCH 230-a. In some other examples, the UE 115-a may be scheduled to transmit the CSI report via a second PUSCH 230-b in accordance with the second processing timeline 215-b. The second processing timeline 215-b may be longer (e.g., more relaxed) than the first processing timeline 215-a. For example, the second PUSCH 230-b may be scheduled for a later point in time (e.g., a following slot) relative to the first PUSCH 230-a. When performing CSI reporting in accordance with the second processing timeline 215-b, the UE 115-a may be configured with (e.g., scheduled with) a longer time to measure the CSI-RS 225 and calculate the CSI report via the PUSCH 230 relative to the first processing timeline 215-a. When performing the CSI-RS measurement and CSI reporting in accordance with the second processing timeline 215-b, the UE 115-a may operate in a lower power state. When performing the CSI-RS measurement and CSI reporting in accordance with the first processing timeline 215-a, the UE 115-a may operate in a higher power state.

In some cases, the processing timeline 215 may correspond to a first timeline threshold, a second timeline threshold, or both. A time threshold may correspond to when the UE 115-a is expected to complete CSI-RS measurement and reporting of a CSI report. The first timeline threshold may start after a last symbol of the PDCCH that indicated the CSI trigger 220 to the UE 115-a. The UE 115-a may monitor for and measure the CSI-RS 225 within the first timeline threshold. Similarly, the second timeline threshold may start after a last symbol of the CSI-RS 225. The UE 115-a may calculate the CSI within the second timeline threshold. The first timeline threshold may be defined by a first value Z, and the second timeline threshold may be defined by a second value Z′. Z, Z′, or both, may be preconfigured at the UE 115-a. Alternatively, or additionally, the network entity 105-a may transmit control signaling to configure the UE 115-a with Z, Z′, or both.

In some examples, the UE 115-a may be configured to perform low-power CSI reporting for WB. The network entity 105-a may transmit one or more CSI-RS 225 via WB, and the UE 115-a may report WB CSI based on the one or more CSI-RS. The UE 115-a may refrain from entering a high-power state to receive the CSI-RS 225 and to report the WB CSI. In the example of FIG. 2, the UE 115-a may receive a first WB CSI trigger 235-a and a second WB CSI trigger 235-b from the network entity 105-a (e.g., via WB). The UE 115-a may monitor for a first WB CSI-RS 240-a and a second WB CSI-RS 240-b associated with the first WB CSI trigger 235-a and the second WB CSI trigger 235-b, respectively, and may transmit a first WB CSI report via a first WB PUSCH 245-a and a second CSI report via a second WB PUSCH 245-b to the network entity 105-a.

Similarly, the UE 115-a may also be configured to perform CSI reporting for NB. For example, in FIG. 2, the UE 115-a may receive one or more NB CSI-RS 250 and may transmit one or more corresponding NB CSI reports via one or more NB PUSCH 255. In some cases, the UE 115-a may receive one or more NB CSI triggers indicating for the UE 115-a to monitor the NB for the one or more NB CSI-RS 250. In some other cases, one or more WB CSI triggers 235 may indicate for the UE to monitor the NB for the one or more NB CSI-RS 250.

The network entity 105-a may schedule the CSI triggers 220 such that the network entity 105-a restricts a quantity of back-to-back CSI triggers 220 transmitted to the UE 115-a to support the UE 115-a operating in a low power state. For example, the network entity 105-a may schedule the WB CSI triggers 235 such that the quantity of WB CSI triggers 235 transmitted in consecutive TTIs (e.g., slots) is less than a threshold quantity of CSI triggers 220 supported by the UE for the second configuration information (e.g., less than or equal to a threshold quantity of WB CSI triggers 235 that the UE 115-a is capable of supporting while operating in the low power state). In some examples, the CSI triggers 220 may be discontinuous. For example, the network entity 105-a may refrain from transmitting any CSI triggers 220, or may refrain from scheduling the UE 115-a, during a discontinuous CSI period 260 that follows a last WB CSI trigger 235. The network entity 105-a may configure the discontinuous CSI period 260 for a quantity X of slots following the last WB CSI trigger 235 (e.g., the second WB CSI trigger 235-b) transmitted by the network entity 105-a. The UE 115-a may calculate WB CSI during the discontinuous CSI period 260, which may provide the UE 115-a with additional time (e.g., within the relaxed timeline) to calculate the WB CSI relative to examples where the UE 115-a is scheduled during the discontinuous CSI period 260. Accordingly, the UE 115-a may remain in the lower-power state while calculating the WB CSI and transmitting the WB CSI report, due to the relaxed reporting timeline.

In the example of FIG. 2, the network entity 105-a may configure X to be two slots, and the UE 115-a may not receive WB CSI triggers 235 during the two slots following the second WB CSI trigger 235-b (e.g., slot 3 and slot 4). The UE 115-a may receive a WB CSI-RS 240 during a first slot (e.g., slot 1) and may be scheduled to transmit the corresponding WB CSI report via a WB PUSCH 245 scheduled for a subsequent slot (e.g., slot 5). The UE 115-a may similarly receive a NB CSI-RS 250 during the first slot and may be scheduled to transmit the corresponding NB CSI report via a NB PUSCH 255 scheduled for the same subsequent slot (e.g., slot 5). However, because the UE 115-a does not expect to receive WB signaling during the discontinuous CSI period 260 (e.g., during slot 3 and slot 4), the UE 115-a may calculate the WB CSI during slot 3 and slot 4. Implementing the discontinuous CSI period 260 may provide the UE 115-a with additional time to perform WB CSI reporting in accordance with the second processing timeline 215-b. In this way, the UE 115-a may compute and report (e.g., calculate) the WB CSI without being in the high-power state, which may reduce power consumption for WB communications at the UE 115-a. Additionally, the UE may still perform NB CSI processing during the discontinuous CSI period 260 as the UE 115-a may still perform such operations while in the low power state.

In some examples, the UE 115-a may perform WB CSI reporting in accordance with the second processing timeline 215-b, the first timeline threshold Z, and the second timeline threshold Z′. The second processing timeline 215-b may be relaxed (e.g., longer) relative to the first processing timeline 215-a. The network entity 105-a may indicate the relaxation of the second processing timeline 215-b to the UE 115-a (e.g., to permit the UE 115-a to operate in the lower power state). For example, in some cases where the network entity 105-a transmits DCI that both triggers CSI reporting and schedules a PUSCH 230 for the CSI reporting (e.g., WB PUSCH 245), the network entity 105-a may indicate for the UE 115-a to scale Z and Z′ by a scaling factor. The UE 115-a may scale Z and Z′ to determine the second processing timeline 215-b, to permit the UE 115-a to operate in the lower power state for WB CSI reporting. In some examples, the scaling factor may be equal to the X slots associated with the discontinuous CSI period 260.

In some other cases where the network entity 105-a transmits separate signals for triggering CSI reporting and scheduling the WB PUSCH 245, the network entity 105-a may schedule the WB PUSCH 245 such that at least Z′ is satisfied. The relaxation of the second processing timeline 215-b may apply to periodic CSI reporting, semi-persistent CSI reporting, and aperiodic CSI reporting. For example, the UE 115-a may perform periodic WB CSI reporting, semi-persistent WB CSI reporting, aperiodic WB CSI reporting or any combination thereof, in accordance with the second processing timeline 215-b (e.g., the relaxed timeline).

In some examples, the UE 115-a may be configured with a timer 265 (e.g., a prohibit timer) by the network entity 105-a (e.g., via control signaling indicating a time duration for the timer 265). The UE 115-a may start the timer 265 when the UE 115-a receives DCI that triggers WB CSI reporting (e.g., receives a WB CSI trigger 235). For example, the UE 115-a may start the timer 265 at a first time t1 after receiving the first WB CSI trigger 235-a. The UE 115-a may restart the timer 265 at every subsequent DCI that triggers WB CSI reporting. For example, the UE 115-a may restart the timer 265 at a second time t2 after receiving the second WB CSI trigger 235-b. Before expiry of the timer 265 (e.g., for the duration of the timer 265), the UE 115-a may not expect to monitor (e.g., may skip monitoring until the timer expires) PDCCH for DCI scheduling a PUSCH 230 for transmitting a CSI report (e.g., a WB PUSCH 245 for transmitting a WB CSI report). Additionally, the UE 115-a may not expect to monitor (e.g., may skip monitoring) for WB CSI-RS 240 (e.g., persistent, semi-persistent) before expiry of the timer 265. In such examples, the network entity 105-a may not prebook or preschedule the WB PUSCH 245 for transmitting the WB CSI report. That is, DCI that includes the WB CSI trigger 235 may not also schedule the WB PUSCH 245 for transmitting the WB CSI report corresponding to the WB CSI trigger 235. In the example of FIG. 2, the timer 265 may expire at the third time t3. After expiration of the timer 265, the UE 115-a may monitor for DCI to schedule a WB PUSCH 245 for transmitting one or more WB CSI reports. The timer 265 may provide the UE 115-a with additional time to calculate WB CSI. Accordingly, the UE 115-a may calculate the WB CSI remain in a lower-power state due to the additional time when performing WB CSI reporting, which may reduce power consumption for WB communications at the UE 115-a.

In some other examples, the network entity 105-b may transmit control signaling to configure the UE 115-a with a reporting cycle (e.g., a CSI-Report cycle) for transmitting WB CSI reports. The reporting cycle may be a time duration, a slot offset, a periodicity, or any combination thereof. For example, the network entity 105-a may configure the UE 115-a with a time duration over which the UE 115-a is to calculate and report CSI (e.g., WB CSI) (e.g., next 50 milliseconds). In other examples, the network entity 105-a may configure the UE 115-a with a slot offset between the CSI trigger 220 and a corresponding PUSCH 230 in which the UE 115-a is to transmit a CSI report (e.g., WB PUSCH 245). Additionally, or alternatively, the network entity 105-a may configure the UE 115-a with a periodicity for reporting WB CSI. For example, the network entity 105-a may indicate a periodicity for monitoring a respective CSI-RS transmissions and transmitting a respective WB CSI respective in a respective PUSCH 230.

Additionally, the reporting cycle may be associated with an active time (e.g., on duration) and an inactive time (e.g., off duration). Performing CSI reporting in accordance with the reporting cycle may prevent CSI triggering during the inactive time of the reporting cycle. For example, during the inactive time, the network entity 105-a may not trigger WB CSI reporting, (e.g., periodic, semi-persistent, aperiodic), and the UE 115-a may not expect WB CSI reporting to be triggered. In some cases, the UE 115-a may receive a WB CSI trigger 235 (e.g., CSI compute command) and may transmit a corresponding WB CSI report via a WB PUSCH 245 (e.g., CSI Report command) within a same active time of a same reporting cycle. Alternatively, or additionally, the UE 115-a may receive the WB CSI trigger 235 during a first active time of a first cycle (e.g., that includes the first active time and a first inactive time) and may transmit the corresponding WB CSI report via a WB PUSCH 245 during a second active time different from the first active duration (e.g., in a second cycle including a second active time and a second inactive time). In some cases, the first active time and the second active time may be associated with different reporting cycles.

The UE 115-a may provide the network entity 105-a with assistance information associated with low-power WB CSI reporting (e.g., computing the CSI in the lower-power mode). In some examples, the UE 115-a may indicate the restriction on the quantity of back-to-back WB CSI triggers 235 (e.g., the threshold quantity of CSI triggers 220) to the network entity 105-a via the assistance information. Additionally, or alternatively, the UE 115-a may indicate a restriction on a quantity of back-to-back CSI processes. For example, the UE 115-a may indicate a first quantity N1 of CSI processes supported by the first processing timeline 215-a (e.g., a baseline timeline), wherein N1 is a positive integer. The UE 115-a may also indicate a second quantity N2 of CSI processes supported by the second processing timeline 215-b (e.g., energy efficient scheduling, low-power state with WB CSI), wherein N2 is a positive integer. The second quantity N2 of CSI processes supported by the second processing timeline 215-b may be less than the first quantity N1 of CSI processes supported by the first processing timeline 215-a. The UE 115-a may also indicate a threshold time duration (e.g., a minimum timeline) between two CSI processes via the assistance information. For example, the UE 115-a may use the assistance information to indicate a gap (e.g., in time) between consecutive CSI triggers during which the network entity 105-a may not transmit another CSI trigger 220, to permit the UE 115-a to perform WB CSI reporting while operating in the lower power state. In some examples, the network entity 105-a may not transmit, and the UE 115-a may not expect, periodic CSI-RS 225, semi-persistent CSI-RS 225, or aperiodic CSI-RS 225, during the gap indicated by the UE 115-a. The network entity 105-a may receive the assistance information and may determine the first power configuration, the second power configuration, or both, based on the assistance information.

In some examples, the UE 115-a may be configured to perform periodic CSI reporting, semi-persistent CSI reporting, aperiodic CSI reporting, or any combination thereof. The UE 115-a may use the second processing timeline 215-b (e.g., relaxed timeline) for periodic WB CSI reporting, semi-persistent WB CSI reporting, and for aperiodic WB CSI reporting, to remain in the lower power state. For example, the UE 115-a may receiving control signaling from the network entity indicating periodic CSI-RS resources, semi-persistent CSI-RS resources, aperiodic CSI-RS resources, or any combination thereof, to monitor for WB CSI reporting, along with corresponding PUSCH resources for one or more corresponding WB CSI reports. The control signaling may indicate for the UE 115-a to utilize the relaxed timeline for the periodic CSI reporting, the semi-persistent WB CSI reporting, the aperiodic WB CSI reporting, or any combination thereof, to enable the UE 115-a to reporting in the lower power state for WB CSI reporting.

In the example of FIG. 2, the UE 115-a may be configured to perform low-power WB CSI reporting. However, in some other examples, the UE 115-a may be configured for additional processes via WB. For example, the UE 115-a may be configured to receive SSBs from the network entity 105-a via WB (e.g., for cell acquisition). The UE 115-a and the network entity 105-a may perform beam management, where the network entity 105-a may sweep over a set of transmit beams and the UE 115-a may sweep over a set of receive beams. The UE 115-a may identify a best transmit beam-receive beam pair based on the sweeping. In some cases, the UE 115-a may report the best transmit beam-receive beam pair (e.g., to the network entity 105-a) in accordance with the second processing timeline 215-b (e.g., the relaxed timeline), using the techniques described herein, to enable the UE 115-a to remain in the lower power state while performing beam sweeping and beam reporting. In some other cases, the UE 115-a may use the best transmit beam-receive beam pair when performing a RACH procedure (e.g., with the network entity 105-a).

Additionally, or alternatively, the UE 115-a may be configured to receive TRSs from the network entity 105-a via WB (e.g., for channel tracking). The network entity 105-a may transmit the TRS to enable the UE 115-a to obtain time synchronization information, frequency synchronization information, or both. In some cases, the UE 115-a may monitor for and measure the TRS to determine a channel metric, such as a channel estimate of a wireless channel between the UE 115-a and the network entity 105-a. The UE 115-a may report the channel estimate (e.g., to the network entity 105-a) in accordance with the second processing timeline 215-b (e.g., the relaxed timeline), using the techniques described herein, to enable the UE 115-a to remain in the lower power state when performing channel metric reporting (e.g., to the network entity 105-a).

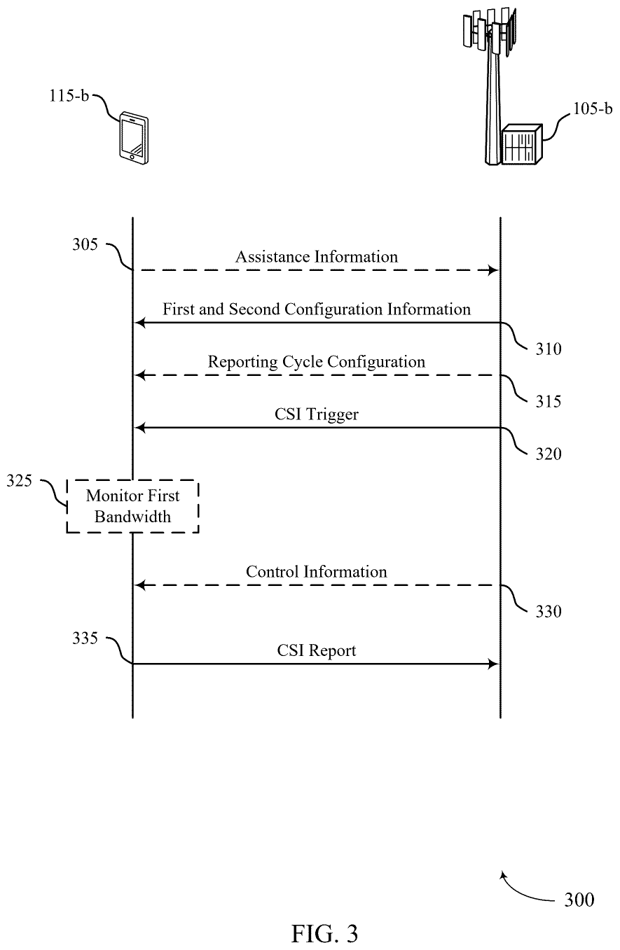

FIG. 3 shows an example of a process flow 300 that supports low-power WB CSI reporting in accordance with one or more aspects of the present disclosure. The process flow 300 may implement or be implemented by aspects of the wireless communications system 100 and the wireless communications system 200, as described with reference to FIGS. 1 and 2. For example, the process flow 300 illustrates actions performed by a UE 115-b and a network entity 105-b, which may be examples of corresponding devices described herein, including with reference to FIGS. 1-2. In the following description of the process flow 300, the operations between the UE 115-b and the network entity 105-b may be performed in a different order than the example shown, or the operations between the UE 115-b and the network entity 105-b may be performed in different orders at different times. Some operations may also be omitted from the process flow 300, and other operations may be added to the process flow 300.

At 305, the UE 115-b may transmit assistance information. In some examples, the UE 115-b may transmit the assistance information to the network entity 105-b. The assistance information may indicate a threshold quantity of CSI triggers supported by the UE 115-b for a second configuration information, a quantity of CSI triggers supported by the UE 115-b for a first configuration information, a threshold time duration between the one or more CSI triggers, or any combination thereof.

At 310, the UE 115-b may receive first configuration information for downlink scheduling in accordance with a first threshold throughput and may receive second configuration information for downlink scheduling in accordance with a second threshold throughput. The second configuration information may be based on the assistance information. In some examples, the second threshold throughput may be less than the first threshold throughput. Additionally, or alternatively, the second configuration information may be associated with a lower power consumption than the first configuration information.

At 315, the UE 115-b may receive a control message indicating a reporting cycle configuration for transmitting a report indicating CSI. The reporting cycle configuration may indicate a duration, a slot offset, a periodicity, an active time, an inactive time, or any combination thereof. Additionally, or alternatively, at 315, the UE 115-b may receive a control message indicating a reporting cycle configuration that identifies a reporting cycle. The reporting cycle may include an active time duration and an inactive time duration. In some cases, the one or more CSI triggers may be received and the report may be transmitted within a same active time duration of the reporting cycle. In some other cases, the one or more CSI triggers may be received during a first active time duration of the reporting cycle and the report may be transmitted during a second active time duration of the reporting cycle. In such cases, the first active time duration may differ from the second active time duration.

At 320, the UE 115-b may receive one or more CSI triggers that may be associated with the second configuration information. A quantity of the one or more CSI triggers may be less than the threshold quantity of CSI triggers supported by the UE 115-b for the second configuration information. In some examples, the UE 115-b may receive control information including the one or more CSI triggers and also scheduling a PUSCH for transmitting the report indicating the CSI. In such examples, a first processing timeline may be scaled by a scaling factor to obtain a second processing timeline based on the control information including the one or more CSI triggers and scheduling the PUSCH for transmitting the report indicating the CSI. The first processing timeline may be associated with the first configuration information, and the second processing timeline may be associated with the second configuration information.

At 325, the UE 115-b may monitor a first bandwidth for one or more reference signals in accordance with the second configuration information and the one or more CSI triggers. The one or more CSI triggers may indicate to monitor for the one or more reference signals. In some examples, the first bandwidth may exceed a second bandwidth.

At 330, the UE 115-b may receive control information scheduling a PUSCH. The PUSCH may be scheduled in accordance with the second processing timeline and in accordance with a timeline threshold. Alternatively, at 330, the UE 115-b may receive control information indicating to initiate a timer. In some examples, monitoring of a control channel may be skipped prior to expiration of the timer. The timer may be restarted upon reception of each of the one or more CSI triggers.

At 335, the UE 115-b may transmit the report indicating the CSI for the one or more reference signals in accordance with the second processing timeline associated with the second configuration information. The second processing timeline may be longer than the first processing timeline associated with the first configuration information. In some examples, the report indicating the CSI may be a periodic CSI report, a semi-persistent CSI report, or an aperiodic CSI report. If the UE 115-b receives the control message indicating the reporting cycle configuration at 315, the UE 115-b may transmit one or more CSI reports in accordance with the reporting cycle configuration.

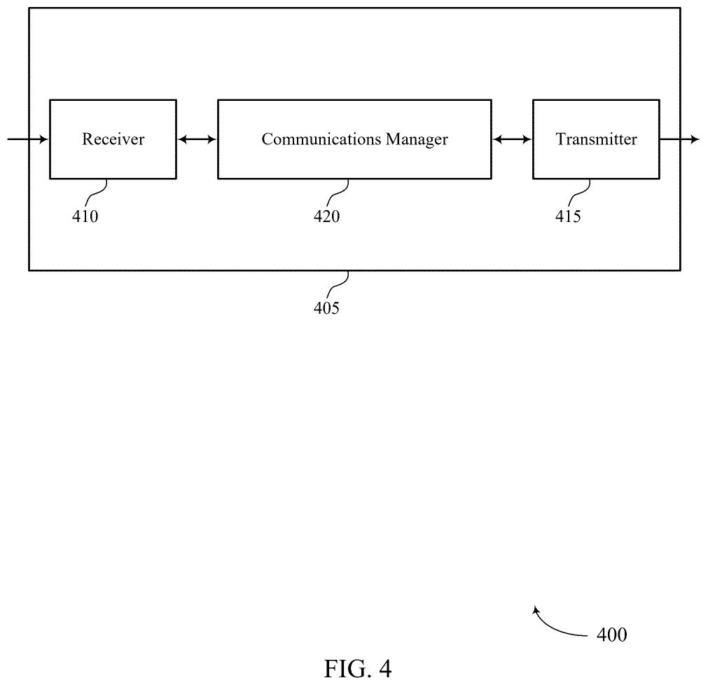

FIG. 4 shows a block diagram 400 of a device 405 that supports low-power WB CSI reporting in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include one or more processors, memory coupled with the one or more processors, and instructions stored in the memory that are executable by the one or more processors to enable the one or more processors to perform the reporting and power management features discussed herein. Each of these components may be in communication with one another (e.g., via one or more buses).

The receiver 410 may provide a means for receiving information such as packets, user data, control information, or any combination thereof associated with various information channels (e.g., control channels, data channels, information channels related to low-power WB CSI reporting). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to low-power WB CSI reporting). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of low-power WB CSI reporting as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving first configuration information for downlink scheduling in accordance with a first threshold throughput and second configuration information for downlink scheduling in accordance with a second threshold throughput, where the second threshold throughput is less than the first threshold throughput. The communications manager 420 is capable of, configured to, or operable to support a means for receiving one or more CSI triggers that is associated with the second configuration information, where a quantity of the one or more CSI triggers is less than a threshold quantity of CSI triggers supported by the UE for the second configuration information. The communications manager 420 is capable of, configured to, or operable to support a means for transmitting a report indicating CSI for one or more reference signals in accordance with a second processing timeline associated with the second configuration information, where the second processing timeline is longer than a first processing timeline associated with the first configuration information.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption.

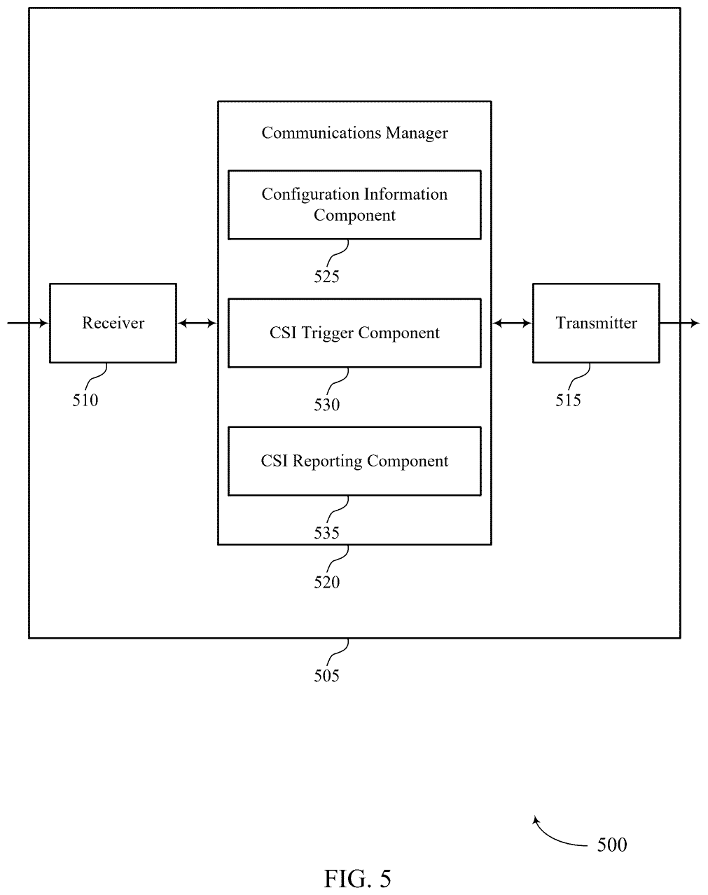

FIG. 5 shows a block diagram 500 of a device 505 that supports low-power WB CSI reporting in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to low-power WB CSI reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to low-power WB CSI reporting). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of low-power WB CSI reporting as described herein. For example, the communications manager 520 may include a configuration information component 525, a CSI trigger component 530, a CSI reporting component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The configuration information component 525 is capable of, configured to, or operable to support a means for receiving first configuration information for downlink scheduling in accordance with a first threshold throughput and second configuration information for downlink scheduling in accordance with a second threshold throughput, where the second threshold throughput is less than the first threshold throughput. The CSI trigger component 530 is capable of, configured to, or operable to support a means for receiving one or more CSI triggers that is associated with the second configuration information, where a quantity of the one or more CSI triggers is less than a threshold quantity of CSI triggers supported by the UE for the second configuration information. The CSI reporting component 535 is capable of, configured to, or operable to support a means for transmitting a report indicating CSI for one or more reference signals in accordance with a second processing timeline associated with the second configuration information, where the second processing timeline is longer than a first processing timeline associated with the first configuration information.

In some cases, the configuration information component 525, the CSI trigger component 530, the CSI reporting component 535, or any combination thereof, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration information component 525, the CSI trigger component 530, the CSI reporting component 535, or any combination thereof, discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

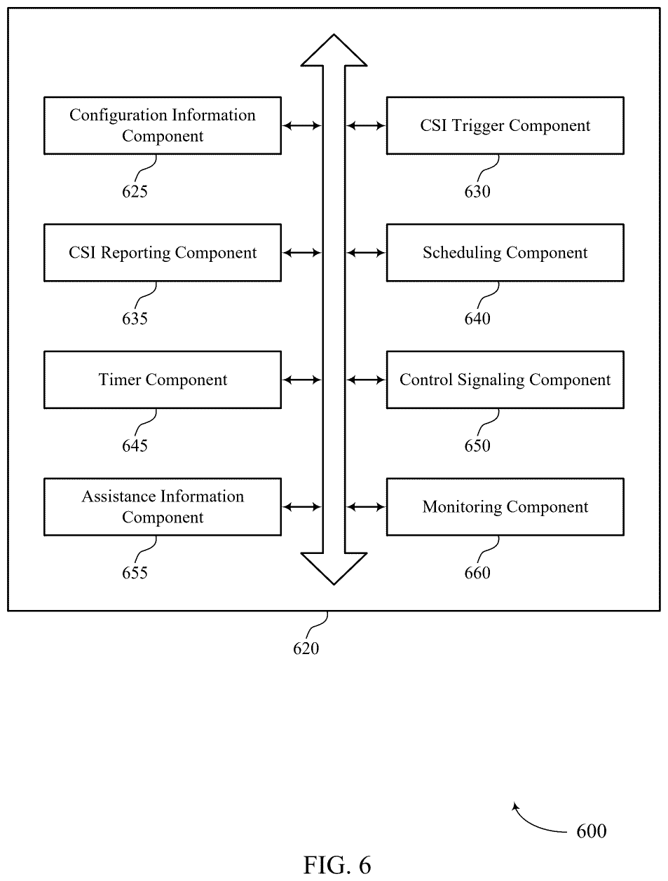

FIG. 6 shows a block diagram 600 of a communications manager 620 that supports low-power WB CSI reporting in accordance with one or more aspects of the present disclosure. The communications manager 620 may be an example of aspects of a communications manager 420, a communications manager 520, or both, as described herein. The communications manager 620, or various components thereof, may be an example of means for performing various aspects of low-power WB CSI reporting as described herein. For example, the communications manager 620 may include a configuration information component 625, a CSI trigger component 630, a CSI reporting component 635, a scheduling component 640, a timer component 645, a control signaling component 650, an assistance information component 655, a monitoring component 660, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The configuration information component 625 is capable of, configured to, or operable to support a means for receiving first configuration information for downlink scheduling in accordance with a first threshold throughput and second configuration information for downlink scheduling in accordance with a second threshold throughput, where the second threshold throughput is less than the first threshold throughput. The CSI trigger component 630 is capable of, configured to, or operable to support a means for receiving one or more CSI triggers that is associated with the second configuration information, where a quantity of the one or more CSI triggers is less than a threshold quantity of CSI triggers supported by the UE for the second configuration information. The CSI reporting component 635 is capable of, configured to, or operable to support a means for transmitting a report indicating CSI for one or more reference signals in accordance with a second processing timeline associated with the second configuration information, where the second processing timeline is longer than a first processing timeline associated with the first configuration information.

In some examples, to support receiving the one or more CSI triggers, the CSI trigger component 630 is capable of, configured to, or operable to support a means for receiving control information including the one or more CSI triggers and scheduling an PUSCH for transmitting the report indicating the CSI, where the first processing timeline is scaled by a scaling factor to obtain the second processing timeline based on the control information including the one or more CSI triggers and scheduling the PUSCH for transmitting the report indicating the CSI.

In some examples, the scheduling component 640 is capable of, configured to, or operable to support a means for receiving control information scheduling an PUSCH, where the PUSCH is scheduled in accordance with the second processing timeline and in accordance with a timeline threshold.

In some examples, the timer component 645 is capable of, configured to, or operable to support a means for receiving control information indicating to initiate a timer, where monitoring of a control channel is skipped prior to expiration of the timer.

In some examples, the timer is restarted upon reception of each of the one or more CSI triggers.

In some examples, the control signaling component 650 is capable of, configured to, or operable to support a means for receiving a control message indicating a reporting cycle configuration for transmitting the report indicating the CSI. In some examples, the CSI reporting component 635 is capable of, configured to, or operable to support a means for transmitting one or more CSI reports in accordance with the reporting cycle configuration.

In some examples, the reporting cycle configuration indicates a duration, a slot offset, a periodicity, an active time, an inactive time, or any combination thereof.

In some examples, the control signaling component 650 is capable of, configured to, or operable to support a means for receiving a control message indicating a reporting cycle configuration that identifies a reporting cycle, the reporting cycle including an active time duration and an inactive time duration, where the one or more CSI triggers is received and the report is transmitted within a same active time duration of the reporting cycle.

In some examples, the control signaling component 650 is capable of, configured to, or operable to support a means for receiving a control message indicating a reporting cycle configuration that identifies a reporting cycle, the reporting cycle including an active time duration and an inactive time duration, where the one or more CSI triggers is received during a first active time duration of the reporting cycle and the report is transmitted during a second active time duration of the reporting cycle, and where the first active time duration differs from the second active time duration.

In some examples, the assistance information component 655 is capable of, configured to, or operable to support a means for transmitting assistance information, the assistance information indicating the threshold quantity of CSI triggers supported by the UE for the second configuration information, a second quantity of CSI triggers supported by the UE for the first configuration information, a threshold time duration between the one or more CSI triggers, or any combination thereof.

In some examples, the monitoring component 660 is capable of, configured to, or operable to support a means for monitoring a first bandwidth for the one or more reference signals in accordance with the second configuration information and the one or more CSI triggers, where the one or more CSI triggers indicate to monitor for the one or more reference signals, and where the first bandwidth exceeds a second bandwidth.

In some examples, the second configuration information is associated with a lower power consumption than the first configuration information.

In some examples, the report indicating the CSI may be a periodic CSI report, a semi-persistent CSI report, or an aperiodic CSI report.

In some cases, the configuration information component 625, the CSI trigger component 630, the CSI reporting component 635, the scheduling component 640, the timer component 645, the control signaling component 650, the assistance information component 655, the monitoring component 660, or any combination thereof, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration information component 625, the CSI trigger component 630, the CSI reporting component 635, the scheduling component 640, the timer component 645, the control signaling component 650, the assistance information component 655, the monitoring component 660, or any combination thereof, discussed herein.”

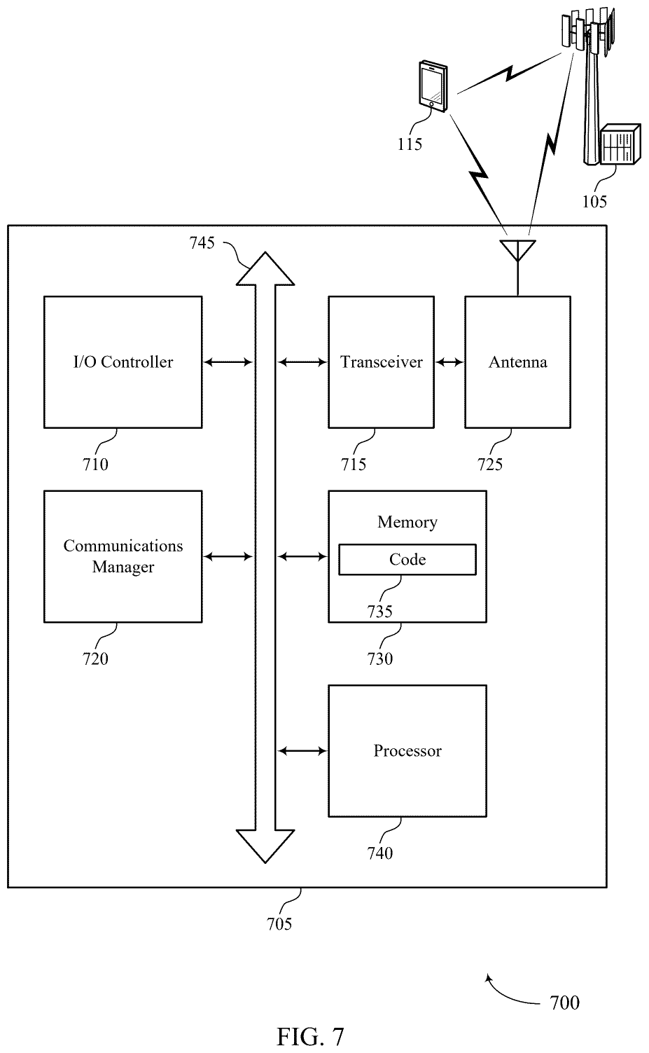

FIG. 7 shows a diagram of a system 700 including a device 705 that supports low-power WB CSI reporting in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting low-power WB CSI reporting). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving first configuration information for downlink scheduling in accordance with a first threshold throughput and second configuration information for downlink scheduling in accordance with a second threshold throughput, where the second threshold throughput is less than the first threshold throughput. The communications manager 720 is capable of, configured to, or operable to support a means for receiving one or more CSI triggers that is associated with the second configuration information, where a quantity of the one or more CSI triggers is less than a threshold quantity of CSI triggers supported by the UE for the second configuration information. The communications manager 720 is capable of, configured to, or operable to support a means for transmitting a report indicating CSI for one or more reference signals in accordance with a second processing timeline associated with the second configuration information, where the second processing timeline is longer than a first processing timeline associated with the first configuration information.

By including or configuring the communications manager 720 in accordance with examples as described herein, the device 705 may support techniques for improved throughput and improved user experience related to reduced power consumption.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of low-power WB CSI reporting as described herein, or the at least one processor 740 and the at least one memory 730 may be otherwise configured to, individually or collectively, perform or support such operations.

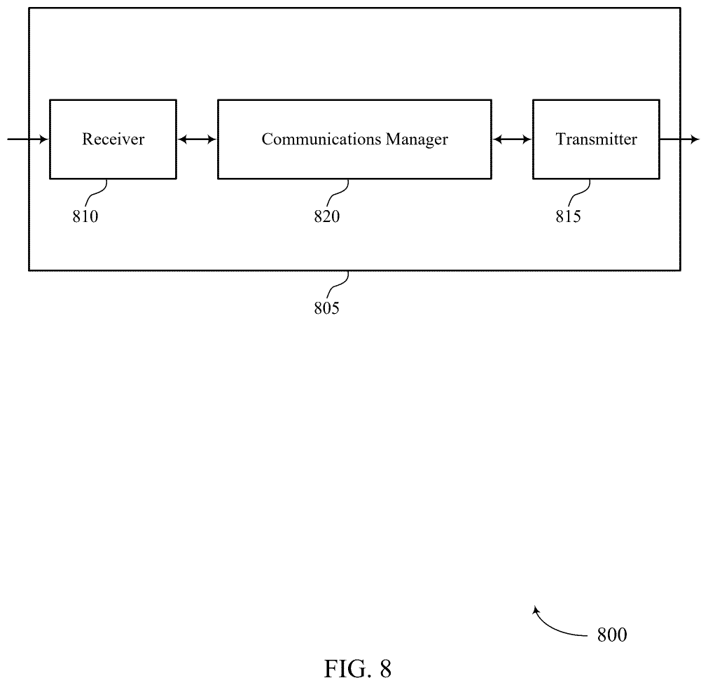

FIG. 8 shows a block diagram 800 of a device 805 that supports low-power WB CSI reporting in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include one or more processors, memory coupled with the one or more processors, and instructions stored in the memory that are executable by the one or more processors to enable the one or more processors to perform the reporting and power management features discussed herein. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of low-power WB CSI reporting as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting first configuration information for downlink scheduling in accordance with a first threshold throughput and second configuration information for downlink scheduling in accordance with a second threshold throughput, where the second threshold throughput is less than the first threshold throughput. The communications manager 820 is capable of, configured to, or operable to support a means for outputting one or more CSI triggers that is associated with the second configuration information, where a quantity of the one or more CSI triggers is less than a threshold quantity of CSI triggers supported by a UE for the second configuration information. The communications manager 820 is capable of, configured to, or operable to support a means for obtaining a report indicating CSI for one or more reference signals in accordance with a second processing timeline associated with the second configuration information, where the second processing timeline is longer than a first processing timeline associated with the first configuration information.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption.

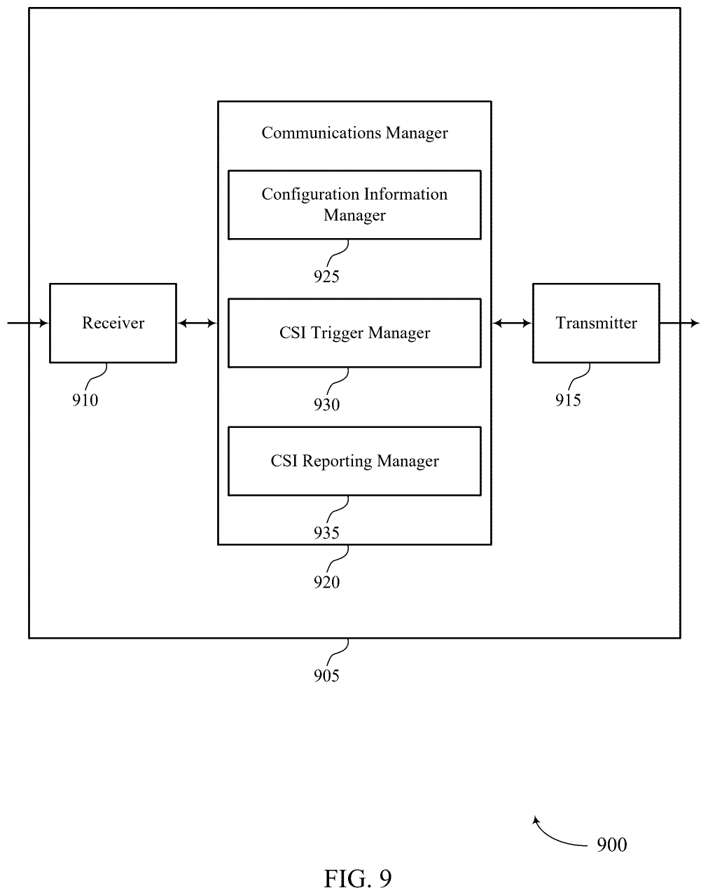

FIG. 9 shows a block diagram 900 of a device 905 that supports low-power WB CSI reporting in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of low-power WB CSI reporting as described herein. For example, the communications manager 920 may include a configuration information manager 925, a CSI trigger manager 930, a CSI reporting manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The configuration information manager 925 is capable of, configured to, or operable to support a means for outputting first configuration information for downlink scheduling in accordance with a first threshold throughput and second configuration information for downlink scheduling in accordance with a second threshold throughput, where the second threshold throughput is less than the first threshold throughput. The CSI trigger manager 930 is capable of, configured to, or operable to support a means for outputting one or more CSI triggers that is associated with the second configuration information, where a quantity of the one or more CSI triggers is less than a threshold quantity of CSI triggers supported by a UE for the second configuration information. The CSI reporting manager 935 is capable of, configured to, or operable to support a means for obtaining a report indicating CSI for one or more reference signals in accordance with a second processing timeline associated with the second configuration information, where the second processing timeline is longer than a first processing timeline associated with the first configuration information.

In some cases, the configuration information manager 925, the CSI trigger manager 930, the CSI reporting manager 935, or any combination thereof, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration information manager 925, the CSI trigger manager 930, the CSI reporting manager 935, or any combination thereof, discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

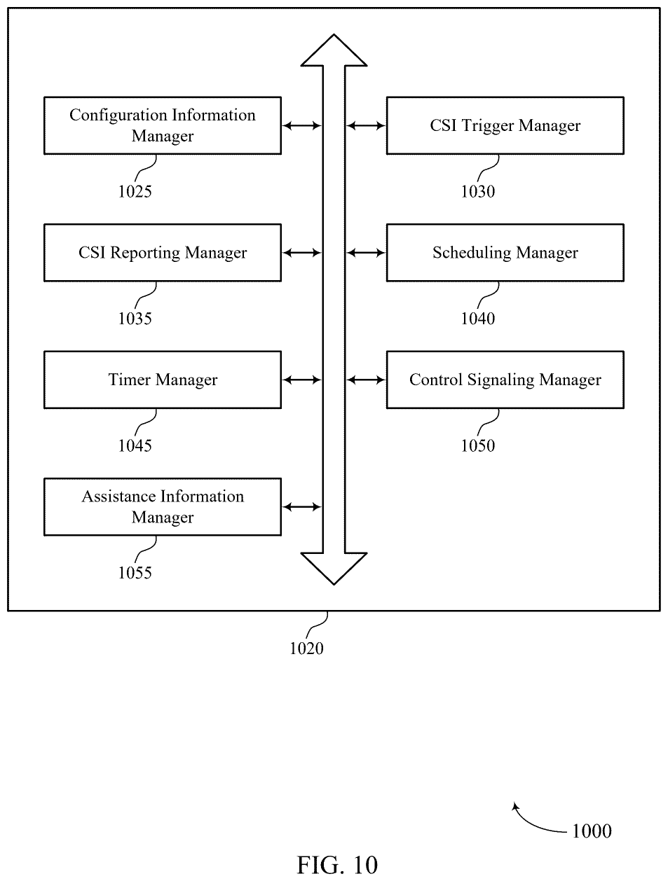

FIG. 10 shows a block diagram 1000 of a communications manager 1020 that supports low-power WB CSI reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of low-power WB CSI reporting as described herein. For example, the communications manager 1020 may include a configuration information manager 1025, a CSI trigger manager 1030, a CSI reporting manager 1035, a scheduling manager 1040, a timer manager 1045, a control signaling manager 1050, an assistance information manager 1055, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The configuration information manager 1025 is capable of, configured to, or operable to support a means for outputting first configuration information for downlink scheduling in accordance with a first threshold throughput and second configuration information for downlink scheduling in accordance with a second threshold throughput, where the second threshold throughput is less than the first threshold throughput. The CSI trigger manager 1030 is capable of, configured to, or operable to support a means for outputting one or more CSI triggers that is associated with the second configuration information, where a quantity of the one or more CSI triggers is less than a threshold quantity of CSI triggers supported by a UE for the second configuration information. The CSI reporting manager 1035 is capable of, configured to, or operable to support a means for obtaining a report indicating CSI for one or more reference signals in accordance with a second processing timeline associated with the second configuration information, where the second processing timeline is longer than a first processing timeline associated with the first configuration information.

In some examples, to support outputting the one or more CSI triggers, the CSI trigger manager 1030 is capable of, configured to, or operable to support a means for outputting control information including the one or more CSI triggers and scheduling an PUSCH for the report indicating the CSI, where the first processing timeline is scaled by a scaling factor to obtain the second processing timeline based on the control information including the one or more CSI triggers and scheduling the PUSCH for the report indicating the CSI.

In some examples, the scheduling manager 1040 is capable of, configured to, or operable to support a means for outputting control information scheduling an PUSCH, where the PUSCH is scheduled in accordance with the second processing timeline and in accordance with a timeline threshold.

In some examples, the timer manager 1045 is capable of, configured to, or operable to support a means for outputting control information indicating to initiate a timer, where monitoring of a control channel is skipped prior to expiration of the timer.

In some examples, the timer is restarted upon output of each of the one or more CSI triggers.

In some examples, the control signaling manager 1050 is capable of, configured to, or operable to support a means for outputting a control message indicating a reporting cycle configuration for the report indicating the CSI. In some examples, the CSI reporting manager 1035 is capable of, configured to, or operable to support a means for obtaining one or more CSI reports in accordance with the reporting cycle configuration.

In some examples, the reporting cycle configuration indicates a duration, a slot offset, a periodicity, an active time, an inactive time, or any combination thereof.

In some examples, the control signaling manager 1050 is capable of, configured to, or operable to support a means for outputting a control message indicating a reporting cycle configuration that identifies a reporting cycle, the reporting cycle including an active time duration and an inactive time duration, where the one or more CSI triggers is output and the report is obtained within a same active time duration of the reporting cycle.

In some examples, the control signaling manager 1050 is capable of, configured to, or operable to support a means for outputting a control message indicating a reporting cycle configuration that identifies a reporting cycle, the reporting cycle including an active time duration and an inactive time duration, where the one or more CSI triggers is output during a first active time duration of the reporting cycle and the report is obtained during a second active time duration of the reporting cycle, and where the first active time duration differs from the second active time duration.

In some examples, the assistance information manager 1055 is capable of, configured to, or operable to support a means for obtaining assistance information, the assistance information indicating the threshold quantity of CSI triggers supported by the UE for the second configuration information, a second quantity of CSI triggers supported by the UE for the first configuration information, a threshold time duration between the one or more CSI triggers, or any combination thereof, where the one or more CSI triggers are output in accordance with the assistance information.

In some examples, the second configuration information is associated with a lower power consumption than the first configuration information.

In some examples, the report indicating the CSI may be a periodic CSI report, a semi-persistent CSI report, or an aperiodic CSI report.

In some cases, the configuration information manager 1025, the CSI trigger manager 1030, the CSI reporting manager 1035, the scheduling manager 1040, the timer manager 1045, the control signaling manager 1050, the assistance information manager 1055, or any combination thereof, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration information manager 1025, the CSI trigger manager 1030, the CSI reporting manager 1035, the scheduling manager 1040, the timer manager 1045, the control signaling manager 1050, the assistance information manager 1055, or any combination thereof, discussed herein.

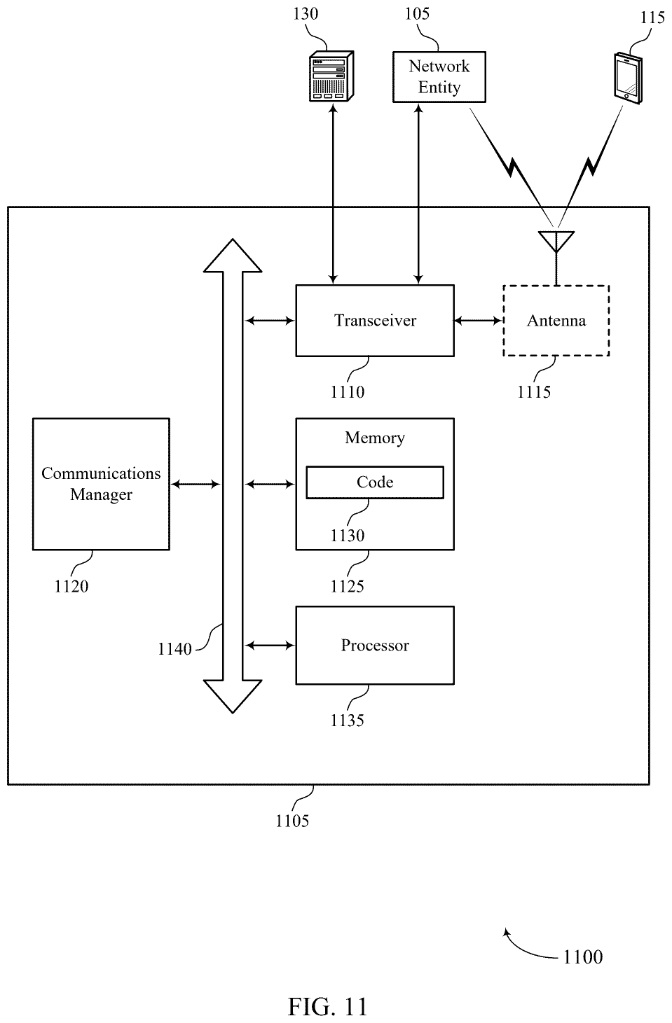

FIG. 11 shows a diagram of a system 1100 including a device 1105 that supports low-power WB CSI reporting in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting low-power WB CSI reporting). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting first configuration information for downlink scheduling in accordance with a first threshold throughput and second configuration information for downlink scheduling in accordance with a second threshold throughput, where the second threshold throughput is less than the first threshold throughput. The communications manager 1120 is capable of, configured to, or operable to support a means for outputting one or more CSI triggers that is associated with the second configuration information, where a quantity of the one or more CSI triggers is less than a threshold quantity of CSI triggers supported by a UE for the second configuration information. The communications manager 1120 is capable of, configured to, or operable to support a means for obtaining a report indicating CSI for one or more reference signals in accordance with a second processing timeline associated with the second configuration information, where the second processing timeline is longer than a first processing timeline associated with the first configuration information.

By including or configuring the communications manager 1120 in accordance with examples as described herein, the device 1105 may support techniques for improved throughput and improved user experience related to reduced power consumption.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of low-power WB CSI reporting as described herein, or the at least one processor 1135 and the at least one memory 1125 may be otherwise configured to, individually or collectively, perform or support such operations.

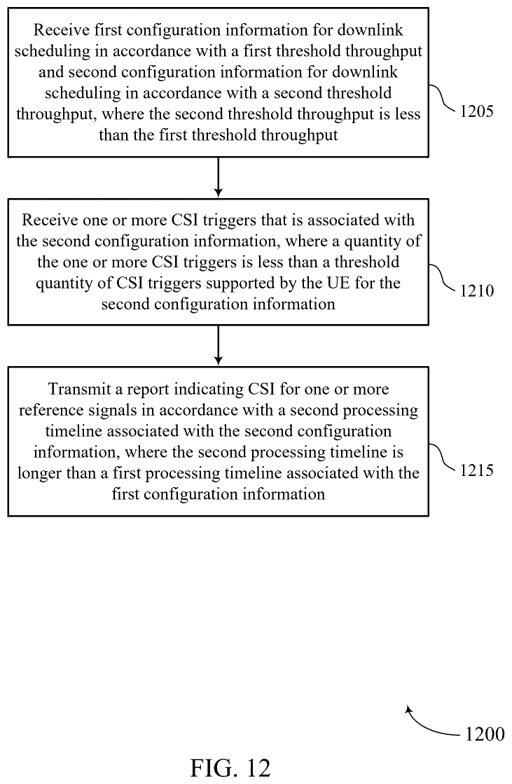

FIG. 12 shows a flowchart illustrating a method 1200 that supports low-power WB CSI reporting in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving first configuration information for downlink scheduling in accordance with a first threshold throughput and second configuration information for downlink scheduling in accordance with a second threshold throughput, where the second threshold throughput is less than the first threshold throughput. The operations of 1205 may be performed in accordance with examples as disclosed herein. In some examples, aspects of the operations of 1205 may be performed by a configuration information component 625 as described with reference to FIG. 6.

At 1210, the method may include receiving one or more CSI triggers that is associated with the second configuration information, where a quantity of the one or more CSI triggers is less than a threshold quantity of CSI triggers supported by the UE for the second configuration information. The operations of 1210 may be performed in accordance with examples as disclosed herein. In some examples, aspects of the operations of 1210 may be performed by a CSI trigger component 630 as described with reference to FIG. 6.

At 1215, the method may include transmitting a report indicating CSI for one or more reference signals in accordance with a second processing timeline associated with the second configuration information, where the second processing timeline is longer than a first processing timeline associated with the first configuration information. The operations of 1215 may be performed in accordance with examples as disclosed herein. In some examples, aspects of the operations of 1215 may be performed by a CSI reporting component 635 as described with reference to FIG. 6.

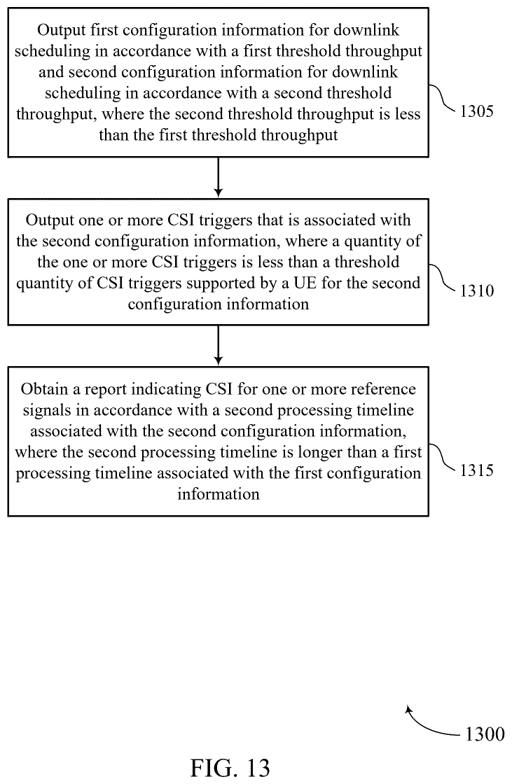

FIG. 13 shows a flowchart illustrating a method 1300 that supports low-power WB CSI reporting in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include outputting first configuration information for downlink scheduling in accordance with a first threshold throughput and second configuration information for downlink scheduling in accordance with a second threshold throughput, where the second threshold throughput is less than the first threshold throughput. The operations of 1305 may be performed in accordance with examples as disclosed herein. In some examples, aspects of the operations of 1305 may be performed by a configuration information manager 1025 as described with reference to FIG. 10.

At 1310, the method may include outputting one or more CSI triggers that is associated with the second configuration information, where a quantity of the one or more CSI triggers is less than a threshold quantity of CSI triggers supported by a UE for the second configuration information. The operations of 1310 may be performed in accordance with examples as disclosed herein. In some examples, aspects of the operations of 1310 may be performed by a CSI trigger manager 1030 as described with reference to FIG. 10.

At 1315, the method may include obtaining a report indicating CSI for one or more reference signals in accordance with a second processing timeline associated with the second configuration information, where the second processing timeline is longer than a first processing timeline associated with the first configuration information. The operations of 1315 may be performed in accordance with examples as disclosed herein. In some examples, aspects of the operations of 1315 may be performed by a CSI reporting manager 1035 as described with reference to FIG. 10.

The following provides an overview of aspects of the present disclosure:

Aspect 1: A method for wireless communications at a UE, comprising: receiving first configuration information for downlink scheduling in accordance with a first threshold throughput and second configuration information for downlink scheduling in accordance with a second threshold throughput, wherein the second threshold throughput is less than the first threshold throughput; receiving one or more CSI triggers that is associated with the second configuration information, wherein a quantity of the one or more CSI triggers is less than a threshold quantity of CSI triggers supported by the UE for the second configuration information; and transmitting a report indicating CSI for one or more reference signals in accordance with a second processing timeline associated with the second configuration information, wherein the second processing timeline is longer than a first processing timeline associated with the first configuration information.

Aspect 2: The method of aspect 1, wherein receiving the one or more CSI triggers further comprises: receiving control information comprising the one or more CSI triggers and scheduling an PUSCH for transmitting the report indicating the CSI, wherein the first processing timeline is scaled by a scaling factor to obtain the second processing timeline based at least in part on the control information comprising the one or more CSI triggers and scheduling the PUSCH for transmitting the report indicating the CSI.

Aspect 3: The method of aspect 1, further comprising: receiving control information scheduling an PUSCH, wherein the PUSCH is scheduled in accordance with the second processing timeline and in accordance with a timeline threshold.

Aspect 4: The method of any of aspects 1 through 3, further comprising: receiving control information indicating to initiate a timer, wherein monitoring of a control channel is skipped prior to expiration of the timer.

Aspect 5: The method of aspect 4, wherein the timer is restarted upon reception of each of the one or more CSI triggers.

Aspect 6: The method of any of aspects 1 through 5, further comprising: receiving a control message indicating a reporting cycle configuration for transmitting the report indicating the CSI; and transmitting one or more CSI reports in accordance with the reporting cycle configuration.

Aspect 7: The method of aspect 6, wherein the reporting cycle configuration indicates a duration, a slot offset, a periodicity, an active time, an inactive time, or any combination thereof.

Aspect 8: The method of aspect 1, further comprising: receiving a control message indicating a reporting cycle configuration that identifies a reporting cycle, the reporting cycle comprising an active time duration and an inactive time duration, wherein the one or more CSI triggers is received and the report is transmitted within a same active time duration of the reporting cycle.

Aspect 9: The method of aspect 1, further comprising: receiving a control message indicating a reporting cycle configuration that identifies a reporting cycle, the reporting cycle comprising an active time duration and an inactive time duration, wherein the one or more CSI triggers is received during a first active time duration of the reporting cycle and the report is transmitted during a second active time duration of the reporting cycle, and wherein the first active time duration differs from the second active time duration.

Aspect 10: The method of any of aspects 1 through 9, further comprising: transmitting assistance information, the assistance information indicating the threshold quantity of CSI triggers supported by the UE for the second configuration information, a second quantity of CSI triggers supported by the UE for the first configuration information, a threshold time duration between the one or more CSI triggers, or any combination thereof.

Aspect 11: The method of any of aspects 1 through 10, further comprising: monitoring a first bandwidth for the one or more reference signals in accordance with the second configuration information and the one or more CSI triggers, wherein the one or more CSI triggers indicate to monitor for the one or more reference signals, and wherein the first bandwidth exceeds a second bandwidth.

Aspect 12: The method of any of aspects 1 through 11, wherein the second configuration information is associated with a lower power consumption than the first configuration information.

Aspect 13: The method of any of aspects 1 through 12, wherein the report indicating the CSI may be a periodic CSI report, a semi-persistent CSI report, or an aperiodic CSI report.

Aspect 14: A method for wireless communications at a network entity, comprising: outputting first configuration information for downlink scheduling in accordance with a first threshold throughput and second configuration information for downlink scheduling in accordance with a second threshold throughput, wherein the second threshold throughput is less than the first threshold throughput; outputting one or more CSI triggers that is associated with the second configuration information, wherein a quantity of the one or more CSI triggers is less than a threshold quantity of CSI triggers supported by a UE for the second configuration information; and obtaining a report indicating CSI for one or more reference signals in accordance with a second processing timeline associated with the second configuration information, wherein the second processing timeline is longer than a first processing timeline associated with the first configuration information.

Aspect 15: The method of aspect 14, wherein outputting the one or more CSI triggers further comprises: outputting control information comprising the one or more CSI triggers and scheduling an PUSCH for the report indicating the CSI, wherein the first processing timeline is scaled by a scaling factor to obtain the second processing timeline based at least in part on the control information comprising the one or more CSI triggers and scheduling the PUSCH for the report indicating the CSI.

Aspect 16: The method of aspect 14, further comprising: outputting control information scheduling an PUSCH, wherein the PUSCH is scheduled in accordance with the second processing timeline and in accordance with a timeline threshold.

Aspect 17: The method of any of aspects 14 through 16, further comprising: outputting control information indicating to initiate a timer, wherein monitoring of a control channel is skipped prior to expiration of the timer.

Aspect 18: The method of aspect 17, wherein the timer is restarted upon output of each of the one or more CSI triggers.

Aspect 19: The method of any of aspects 14 through 18, further comprising: outputting a control message indicating a reporting cycle configuration for the report indicating the CSI; and obtaining one or more CSI reports in accordance with the reporting cycle configuration.

Aspect 20: The method of aspect 19, wherein the reporting cycle configuration indicates a duration, a slot offset, a periodicity, an active time, an inactive time, or any combination thereof.

Aspect 21: The method of aspect 14, further comprising: outputting a control message indicating a reporting cycle configuration that identifies a reporting cycle, the reporting cycle comprising an active time duration and an inactive time duration, wherein the one or more CSI triggers is output and the report is obtained within a same active time duration of the reporting cycle.

Aspect 22: The method of aspect 14, further comprising: outputting a control message indicating a reporting cycle configuration that identifies a reporting cycle, the reporting cycle comprising an active time duration and an inactive time duration, wherein the one or more CSI triggers is output during a first active time duration of the reporting cycle and the report is obtained during a second active time duration of the reporting cycle, and wherein the first active time duration differs from the second active time duration.

Aspect 23: The method of any of aspects 14 through 22, further comprising: obtaining assistance information, the assistance information indicating the threshold quantity of CSI triggers supported by the UE for the second configuration information, a second quantity of CSI triggers supported by the UE for the first configuration information, a threshold time duration between the one or more CSI triggers, or any combination thereof, wherein the one or more CSI triggers are output in accordance with the assistance information.

Aspect 24: The method of any of aspects 14 through 23, wherein the second configuration information is associated with a lower power consumption than the first configuration information.

Aspect 25: The method of any of aspects 14 through 24, wherein the report indicating the CSI may be a periodic CSI report, a semi-persistent CSI report, or an aperiodic CSI report.

Aspect 26: A UE for wireless communications, comprising one or more memories storing processor-executable code, and one or more processors coupled with the one or more memories and individually or collectively operable to execute the code to cause the UE to perform a method of any of aspects 1 through 13.

Aspect 27: A UE for wireless communications, comprising at least one means for performing a method of any of aspects 1 through 13.

Aspect 28: A non-transitory computer-readable medium storing code for wireless communications, the code comprising instructions executable by one or more processors to perform a method of any of aspects 1 through 13.

Aspect 29: A network entity for wireless communications, comprising one or more memories storing processor-executable code, and one or more processors coupled with the one or more memories and individually or collectively operable to execute the code to cause the network entity to perform a method of any of aspects 14 through 25.

Aspect 30: A network entity for wireless communications, comprising at least one means for performing a method of any of aspects 14 through 25.

Aspect 31: A non-transitory computer-readable medium storing code for wireless communications, the code comprising instructions executable by one or more processors to perform a method of any of aspects 14 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first configuration information for downlink scheduling in accordance with a first threshold throughput and second configuration information for downlink scheduling in accordance with a second threshold throughput, wherein the second threshold throughput is less than the first threshold throughput;
receive one or more channel state information (CSI) triggers that is associated with the second configuration information, wherein a quantity of the one or more CSI triggers is less than a threshold quantity of CSI triggers supported by the UE for the second configuration information; and
transmit a report indicating CSI for one or more reference signals in accordance with a second processing timeline associated with the second configuration information, wherein the second processing timeline is longer than a first processing timeline associated with the first configuration information.

2. The UE of claim 1, wherein, to receive the one or more CSI triggers, the one or more processors are individually or collectively further operable to execute the code to cause the UE to:
receive control information comprising the one or more CSI triggers and scheduling a physical uplink shared channel (PUSCH) for transmitting the report indicating the CSI, wherein the first processing timeline is scaled by a scaling factor to obtain the second processing timeline based at least in part on the control information comprising the one or more CSI triggers and scheduling the PUSCH for transmitting the report indicating the CSI.

3. The UE of claim 1, wherein the one or more processors are individually or collectively further operable to execute the code to cause the UE to:
receive control information scheduling a physical uplink shared channel (PUSCH), wherein the PUSCH is scheduled in accordance with the second processing timeline and in accordance with a timeline threshold.

4. The UE of claim 1, wherein the one or more processors are individually or collectively further operable to execute the code to cause the UE to:
receive control information indicating to initiate a timer, wherein monitoring of a control channel is skipped prior to expiration of the timer.

5. The UE of claim 4, wherein the timer is restarted upon reception of each of the one or more CSI triggers.

6. The UE of claim 1, wherein the one or more processors are individually or collectively further operable to execute the code to cause the UE to:
receive a control message indicating a reporting cycle configuration for transmitting the report indicating the CSI; and
transmit one or more CSI reports in accordance with the reporting cycle configuration.

7. The UE of claim 6, wherein the reporting cycle configuration indicates a duration, a slot offset, a periodicity, an active time, an inactive time, or any combination thereof.

8. The UE of claim 1, wherein the one or more processors are individually or collectively further operable to execute the code to cause the UE to:
receive a control message indicating a reporting cycle configuration that identifies a reporting cycle, the reporting cycle comprising an active time duration and an inactive time duration, wherein the one or more CSI triggers is received and the report is transmitted within a same active time duration of the reporting cycle.

9. The UE of claim 1, wherein the one or more processors are individually or collectively further operable to execute the code to cause the UE to:
receive a control message indicating a reporting cycle configuration that identifies a reporting cycle, the reporting cycle comprising an active time duration and an inactive time duration, wherein the one or more CSI triggers is received during a first active time duration of the reporting cycle and the report is transmitted during a second active time duration of the reporting cycle, and wherein the first active time duration differs from the second active time duration.

10. The UE of claim 1, wherein the one or more processors are individually or collectively further operable to execute the code to cause the UE to:
transmit assistance information, the assistance information indicating the threshold quantity of CSI triggers supported by the UE for the second configuration information, a second quantity of CSI triggers supported by the UE for the first configuration information, a threshold time duration between the one or more CSI triggers, or any combination thereof.

11. The UE of claim 1, wherein the one or more processors are individually or collectively further operable to execute the code to cause the UE to:
monitor a first bandwidth for the one or more reference signals in accordance with the second configuration information and the one or more CSI triggers, wherein the one or more CSI triggers indicate to monitor for the one or more reference signals, and wherein the first bandwidth exceeds a second bandwidth.

12. The UE of claim 1, wherein the second configuration information is associated with a lower power consumption than the first configuration information.

13. The UE of claim 1, wherein the report indicating the CSI may be a periodic CSI report, a semi-persistent CSI report, or an aperiodic CSI report.

14. A network entity, comprising:
one or more memories storing processor-executable code; and
one or more processors coupled with the one or more memories and individually or collectively operable to execute the code to cause the network entity to:
output first configuration information for downlink scheduling in accordance with a first threshold throughput and second configuration information for downlink scheduling in accordance with a second threshold throughput, wherein the second threshold throughput is less than the first threshold throughput;
output one or more channel state information (CSI) triggers that is associated with the second configuration information, wherein a quantity of the one or more CSI triggers is less than a threshold quantity of CSI triggers supported by a user equipment (UE) for the second configuration information; and
obtain a report indicating CSI for one or more reference signals in accordance with a second processing timeline associated with the second configuration information, wherein the second processing timeline is longer than a first processing timeline associated with the first configuration information.

15. The network entity of claim 14, wherein, to output the one or more CSI triggers, the one or more processors are individually or collectively further operable to execute the code to cause the network entity to:
output control information comprising the one or more CSI triggers and scheduling a physical uplink shared channel (PUSCH) for the report indicating the CSI, wherein the first processing timeline is scaled by a scaling factor to obtain the second processing timeline based at least in part on the control information comprising the one or more CSI triggers and scheduling the PUSCH for the report indicating the CSI.

16. The network entity of claim 14, wherein the one or more processors are individually or collectively further operable to execute the code to cause the network entity to:
output control information scheduling a physical uplink shared channel (PUSCH), wherein the PUSCH is scheduled in accordance with the second processing timeline and in accordance with a timeline threshold.

17. The network entity of claim 14, wherein the one or more processors are individually or collectively further operable to execute the code to cause the network entity to:
output control information indicating to initiate a timer, wherein monitoring of a control channel is skipped prior to expiration of the timer.

18. The network entity of claim 17, wherein the timer is restarted upon output of each of the one or more CSI triggers.

19. The network entity of claim 14, wherein the one or more processors are individually or collectively further operable to execute the code to cause the network entity to:
output a control message indicating a reporting cycle configuration for the report indicating the CSI; and
obtain one or more CSI reports in accordance with the reporting cycle configuration.

20. The network entity of claim 19, wherein the reporting cycle configuration indicates a duration, a slot offset, a periodicity, an active time, an inactive time, or any combination thereof.

21. The network entity of claim 14, wherein the one or more processors are individually or collectively further operable to execute the code to cause the network entity to:
output a control message indicating a reporting cycle configuration that identifies a reporting cycle, the reporting cycle comprising an active time duration and an inactive time duration, wherein the one or more CSI triggers is output and the report is obtained within a same active time duration of the reporting cycle.

22. The network entity of claim 14, wherein the one or more processors are individually or collectively further operable to execute the code to cause the network entity to:
output a control message indicating a reporting cycle configuration that identifies a reporting cycle, the reporting cycle comprising an active time duration and an inactive time duration, wherein the one or more CSI triggers is output during a first active time duration of the reporting cycle and the report is obtained during a second active time duration of the reporting cycle, and wherein the first active time duration differs from the second active time duration.

23. The network entity of claim 14, wherein the one or more processors are individually or collectively further operable to execute the code to cause the network entity to:
obtain assistance information, the assistance information indicating the threshold quantity of CSI triggers supported by the UE for the second configuration information, a second quantity of CSI triggers supported by the UE for the first configuration information, a threshold time duration between the one or more CSI triggers, or any combination thereof, wherein the one or more CSI triggers are output in accordance with the assistance information.

24. The network entity of claim 14, wherein the second configuration information is associated with a lower power consumption than the first configuration information.

25. The network entity of claim 14, wherein the report indicating the CSI may be a periodic CSI report, a semi-persistent CSI report, or an aperiodic CSI report.

26. A method for wireless communications at a user equipment (UE), comprising:
receiving first configuration information for downlink scheduling in accordance with a first threshold throughput and second configuration information for downlink scheduling in accordance with a second threshold throughput, wherein the second threshold throughput is less than the first threshold throughput;
receiving one or more channel state information (CSI) triggers that is associated with the second configuration information, wherein a quantity of the one or more CSI triggers is less than a threshold quantity of CSI triggers supported by the UE for the second configuration information; and
transmitting a report indicating CSI for one or more reference signals in accordance with a second processing timeline associated with the second configuration information, wherein the second processing timeline is longer than a first processing timeline associated with the first configuration information.

27. The method of claim 26, wherein receiving the one or more CSI triggers further comprises:
receiving control information comprising the one or more CSI triggers and scheduling a physical uplink shared channel (PUSCH) for transmitting the report indicating the CSI, wherein the first processing timeline is scaled by a scaling factor to obtain the second processing timeline based at least in part on the control information comprising the one or more CSI triggers and scheduling the PUSCH for transmitting the report indicating the CSI.

28. The method of claim 26, further comprising:
monitoring a first bandwidth for the one or more reference signals in accordance with the second configuration information and the one or more CSI triggers, wherein the one or more CSI triggers indicate to monitor for the one or more reference signals, and wherein the first bandwidth exceeds a second bandwidth.

29. A method for wireless communications at a network entity, comprising:
outputting first configuration information for downlink scheduling in accordance with a first threshold throughput and second configuration information for downlink scheduling in accordance with a second threshold throughput, wherein the second threshold throughput is less than the first threshold throughput;
outputting one or more channel state information (CSI) triggers that is associated with the second configuration information, wherein a quantity of the one or more CSI triggers is less than a threshold quantity of CSI triggers supported by a user equipment (UE) for the second configuration information; and
obtaining a report indicating CSI for one or more reference signals in accordance with a second processing timeline associated with the second configuration information, wherein the second processing timeline is longer than a first processing timeline associated with the first configuration information.

30. The method of claim 29, further comprising:
outputting control information scheduling a physical uplink shared channel (PUSCH), wherein the PUSCH is scheduled in accordance with the second processing timeline and in accordance with a timeline threshold.
